(19) United States
(12) Patent Application Publication
(10) Pub. No.: US 2016/0255987 A1
(43) Pub. Date: Sep. 8, 2016

(54) ADAPTER FOR USE IN A COFFEE MACHINE

(71) Applicant: Koninklijke Douwe Egberts B.V., Utrecht (NL)

(72) Inventors: Gerbrand Kristiaan de Graaff, Utrecht (NL); Gustaaf Frans Brouwer, Utrecht (NL); Christiaan Johannes Maria Moorman, Utrecht (NL)

(73) Assignee: KONINKLIJKE DOUWE EGBERTS B.V., Utrecht (NL)

(21) Appl. No.: 14/874,200

(22) Filed: Oct. 2, 2015

Related U.S. Application Data
(63) Continuation of application No. PCT/NL2014/050207, filed on Apr. 3, 2014.

(30) Foreign Application Priority Data
Apr. 3, 2013 (NL) 2010564

(51) Int. Cl. A47J 31/06; A23F 5/26

(52) U.S. Cl. CPC A47J 31/0647; A23F 5/262

(57) ABSTRACT

Adapter for use in a coffee machine in combination with a pad, which pad comprises a covering of filtering sheet material enclosing a beverage preparation product. The coffee machine is equipped with a pad holder having a bowl-shaped interior for accommodating the adapter in combination with the pad, the coffee machine having a water inlet and is arranged for supplying a time controlled amount of water to the pad positioned in the pad holder, the pad holder having a beverage exit opening. The adapter comprises a rigid disc-shaped body having a beverage collecting structure on an upper surface and a perimeter arranged for sealing engagement with the pad holder of the beverage machine, and for positioning between the pad and the beverage exit opening, wherein the adapter has a restricted opening extending there through to reduce in volume a beverage leaving the pad and flowing to the beverage exit opening of the pad holder.

### CROSS-REFERENCE TO RELATED PATENT APPLICATIONS

This Application is a continuation of International Patent Application No. PCT/NL2014/050207, filed Apr. 3, 2014, which claims the benefit of priority to Netherlands Application No. NL2010564, filed Apr. 3, 2013, all of which are hereby incorporated herein by reference in their entireties.

### BACKGROUND

The invention relates to an adapter for use in a beverage machine, such as a coffee machine, and particularly in combination with a pad containing a beverage preparation product.

### SUMMARY

It has been known to offer pads containing a specific beverage preparation product in combination with a dedicated holder to enable its use in a Senseo® hot water appliance for the extraction of such pads made of filter material. Examples thereof include the Senseo® Espresso pad holder in combination with an espresso pad and the Senseo® tea pad holder in combination with a tea pad. This combination of pad and dedicated holder enables the preparation of a specific drinks with a Senseo® coffee machine. However the dedicated holder, which replaces the regular pad holder supplied with the machine, requires a substantial investment and confuses the user as it makes it difficult to discern between the various holders, when deciding on a different beverage.

There has also been a desire to be able to prepare different coffee varieties with the standard Senseo® machine, but the prospect of having a myriad variety of pad holders has slowed down the development of such options. Amongst such desirable varieties are smaller volumes of coffee beverage having a higher dry matter content and a stronger and more intense taste. Other desirable varieties include cappuccinos, latte macchiato, and Wiener melange, which are best prepared in a two-step process.

Accordingly it is an object of the present invention to propose an adapter that can be used in combination with a standard pad holder. More generally it is thus an object of the invention to overcome or ameliorate at least one of the disadvantages of the prior art. It is also an object of the present invention to provide alternative structures which are less cumbersome in assembly and operation and which moreover can be made relatively inexpensively. Alternatively it is an object of the invention to at least provide the public with a useful alternative.

To this end the invention provides an adapter, an assembly, a system, and a method as defined in one or more of the appended claims.

Notably the adapter according to the invention is an adapter for use in a coffee machine in combination with a pad, which pad comprises a covering of filtering sheet material enclosing a beverage preparation product, and which coffee machine is equipped with a pad holder having a bowl-shaped interior for accommodating the adapter in combination with the pad, the coffee machine having a water inlet and is arranged for supplying a time controlled amount of water to the pad positioned in the pad holder, the pad holder having a beverage exit opening, the adapter comprising a rigid disc-shaped body having a beverage collecting structure on an upper surface and a perimeter arranged for sealing engagement with the pad holder of the beverage machine, and for positioning between the pad and the beverage exit opening, wherein the adapter has a restricted opening extending there through to reduce in volume a beverage leaving the pad and flowing to the beverage exit opening of the pad holder. Such an adapter, when used in an appliance with a time controlled water supply, such as the Senseo® coffee machine, results in a smaller volume of beverage. With a standard coffee pad, a coffee beverage can be prepared with a smaller volume. With suitably adapted pads, containing different beverage preparation product, it is now also possible to prepare a single serving of beverage in a two-step process, such as cappuccinos, latte macchiato, Wiener melange, or like beverages. In such a two-step process at least one of the pads used with the adapter will be a pad containing a creamer.

Advantageously the perimeter includes a flexible perimeter flange, and preferably the perimeter flange is also resilient. Thereby a sealing engagement with the pad holder of the beverage machine may be established.

Optionally the perimeter may also include an upstanding wall that defines a bowl-shaped interior. Then the sealing engagement with the pad holder of the beverage machine, may be combined with the sealing arrangement for the pad, as provided on the pad holder.

Also advantageously the beverage collecting structure may include a plurality of radial channels defined between a plurality of radial ridges protruding from the upper surface. Advantageously these radial channels then converge toward the restricted opening. To ensure that the prepared beverage can freely flow from the pad to the restricted opening, the pad both needs to be supported, but also not be obstructed on its outflow side, which is the bottom side.

For the restricted opening it is preferred to have a diameter less than 0.83 mm, and preferably a diameter within a range from 0.58 to 0.64 mm. A standard Senseo® coffee machine, in its default setting, prepares on average 110-130 ml of beverage. For the restricted opening to form a restriction, and produce less beverage, it needs to have a diameter smaller than a nozzle in an outflow funnel of the standard pad holder of the Senseo® coffee machine. It should be clear in this regard, that the opening and nozzle need not be circular and have a diameter. In that case a diameter of 0.83 mm corresponds to a through-flow opening having an opening area of 0.54 mm2. A range from 0.58 to 0.64 mm, would then correspond to a through-flow opening area from 0.26 to 0.32 mm2.

Also advantageously the adapter may include flow converting means for converting a flow of beverage downstream of the restricted opening into a laminar flow. A laminar flow is important when use is to be made of a beverage foaming arrangement of a pad holder. Establishing a laminar flow can be of advantage when the restricted opening in the adapter has caused a turbulent flow to exit therefrom. Alternatively the flow converting means may include a labyrinth flow path. In such a case the labyrinth flow path can advantageously be defined between the adapter and the pad holder. Also alternatively flow converting means may include a deflector plate, spaced from the disc-shaped body downstream of the restricted opening. Such a deflector plate can then be spaced from the disc-shaped body by a plurality of radial ribs. Advantageously the radial ribs can be integral with the disc-shaped body. Furthermore the deflector plate can be bonded to the radial ribs and/or the deflector plate can be a foil. Such arrangements allow the beverage flow from the restricted opening to radially spread out over an upper surface of the deflector plate, or through the labyrinth, which reduces the turbulence. Also such structures are relatively cost effective in manufacture.

It may also be advantageous when the adapter is made from a resin such as a plastic, more particularly a PP polymer, a biodegradable plastic, a bio-based plastic, and cardboard. Thereby, the adapter preferably is substantially impermeable to aqueous fluids. Such a material selection may further reduce manufacturing costs of the adapter, when this is supplied as a disposable together with a pre-packaged set of beverage pads.

Furthermore a substantially circular ridge extending downwardly from a lower surface may additionally be provided, and adapted to extend into a recess in the pad holder. Such a ridge may assist in placing the adapter in a pad holder, and may also ensure that the adapter is kept at a predetermined distance from a bottom of the pad holder.

Alternatively the adapter according to one or more of the above embodiments can be bonded to a pad comprising a covering of filtering sheet material enclosing a beverage preparation product. This may enhance the handling of the pad and adapter during positioning in the pad holder of a beverage machine.

Notably the invention also relates to a system including a coffee machine equipped with a pad holder comprising at least one beverage exit opening and being arranged for accommodating a pad, a lid for closing the holder, and fluid supply means for generating a time controlled amount of water under pressure into the holder, wherein the system further comprises the adapter as mentioned above, and at least one pad with a covering of filtering sheet material enclosing a beverage preparation product suitable for use in the coffee machine. In such a system the adapter advantageously forms a fluid seal with the pad holder, so that a flow of water around the pad is prevented. In a brewing process using the adapter of the present invention it is important that there is a good primary static seal between the adapter and the pad holder, to enable sufficient pressure built-up for the beverage to reach the restricted opening. It is further important that a dynamic fluid seal is also maintained throughout the brewing process. A dynamic fluid seal means that the fluid pressure is used to good effect to improve on the static seal when the pressure increases. In this regard it may thus be of further advantageous when the seal formed between the adapter and the pad holder is at least one of a static and a dynamic seal. A static seal can be formed between an outwardly extending perimeter flange of the adapter and a confronting flat top flange of the holder. A dynamic fluid seal with the holder, can be formed at an underside of the adapter, so that a flow of aqueous fluid from a top side of the pad around the pad to the beverage exit opening of the holder is prevented.

To enhance the sealing properties it may also be of advantage when the adapter has a shape that corresponds to a shape of the pad holder.

The pad holder can advantageously be designed as a removable pad holder, with the removable pad holder having a bowl-shaped interior for receiving the pad. Removability of the pad holder will make it more easy for a consumer to position the adapter and pad in the beverage machine.

Best results are obtained when the water is supplied at a pressure of 1.5-2.2 bar, preferably 1.8-2.0 bar absolute pressure and/or when 50-120 ml, preferably 75-95 ml beverage is prepared with the system.

A further optimal use of the system can be made when the pad holder is equipped with a nozzle for generating a jet of the beverage.

In a further embodiment according to the invention the restricted opening has a diameter that is smaller than a diameter of the nozzle of the holder. In this regard it is advantageous, when the restricted opening has a diameter less than 0.83 mm, and preferably a diameter within a range from 0.58 to 0.64 mm. In combination with any of these features, it may further be advantageous when the adapter additionally includes flow converting means for converting a flow of beverage downstream of the restricted opening into a laminar flow.

The invention notably also relates to a method for preparing at least one part of a single beverage serving with an adapter according to one of previously discussed embodiments. As part of this method a pad and the adapter are placed in a pad holder that is equipped with at least one beverage exit opening, closing the holder containing the pad with a lid that has at least one fluid opening, supplying hot water under pressure to the at least one fluid opening, so that the hot water is fed to the beverage preparation product in the pad, allowing a beverage formed in the pad to leave the pad via the restricted opening of the adapter, and allowing the beverage to leave the pad holder through the at least one beverage exit opening. Performing this method will result in a beverage with a high dry matter content and an increased intensity or strength, with a more intense taste. In this regard it is again helpful when the hot water is supplied, at a pressure of 1.5-2.2 bar, preferably 1.8-2.0 bar absolute pressure and/or when 50-120 ml, preferably 75-95 ml beverage is prepared by the method.

### BRIEF DESCRIPTION OF THE DRAWINGS

Further advantageous aspects of the invention will become clear from the appended description and in reference to the accompanying drawings, in which:

FIG. 1 is a detailed view typical of a Senseo® coffee machine with a time controlled brewing fluid supply;

FIG. 2 is an exploded arrangement partly in cross section, of a standard soft coffee pad, an adapter according to the present invention and a holder of a typical Senseo® coffee machine;

FIG. 3 is a detailed view in cross section of the other elements of FIG. 2 accommodated in the holder of FIG. 2;

FIG. 4 is an arrangement, party in cross section, of a standard soft coffee pad and a first alternative form of adapter according to the invention;

FIG. 5 is a bottom perspective view of the first of adapter of FIG. 4;

FIG. 6 is a bottom perspective view of a second alternative form of adapter according to the invention;

FIG. 7 is a detailed view of FIG. 6 on an enlarged scale;

FIG. 8 is an exploded view from below of a third alternative form of adapter according to the invention;

FIG. 9 is a bottom perspective view of the third alternative form of adapter of FIG. 8 in assembled form;

FIG. 10A in a partial transverse cross sectional shows the adapter and pad accommodated in the holder, without fluid pressure, and forming a static fluid seal; and

FIG. 10B in a partial transverse cross sectional shows the adapter and pad accommodated in the holder, when pressed down by fluid pressure, and forming a dynamic fluid seal.

### DETAILED DESCRIPTION

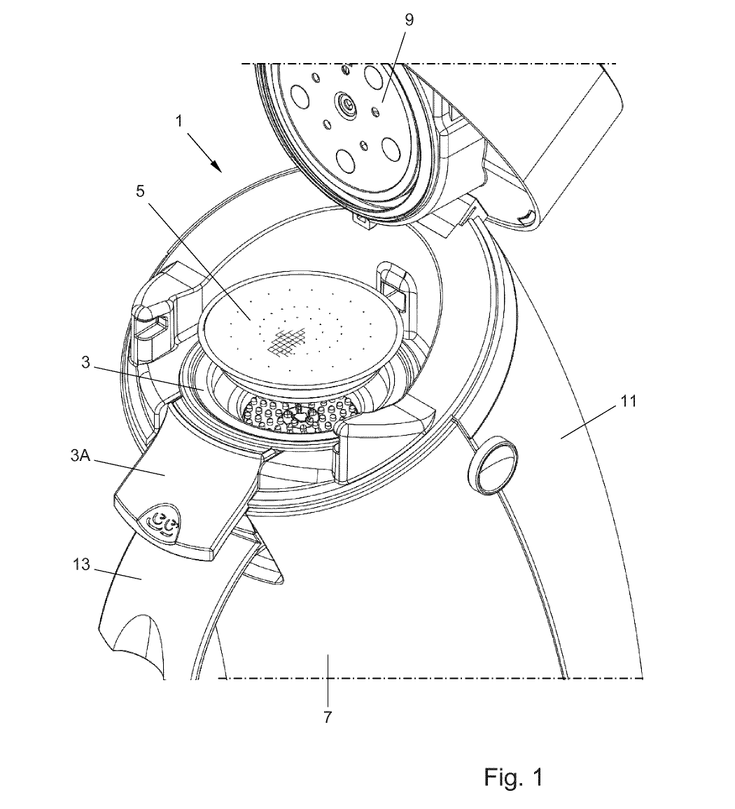

In FIG. 1 a typical Senseo® coffee machine 1 is shown. As is well known, this type of coffee machine has a removable pad holder 3 that is adapted to accommodate and hold a pad 5 containing a soluble or extractable beverage preparation product. The pad holder 3 has a handle 3A. After insertion of the pad 5 in the pad holder 3 and receiving same in a body 7 of the machine a lid 9 is closed onto the holder 3 and the pad 5. When the machine 1 is then operated, water taken from a water reservoir 11 is heated by the machine and then supplied under pressure through the lid 9 for a predetermined period of time. After dissolving or extracting the beverage product from the pad 5 a beverage leaves the machine 1 through exit spout 13. In its normal operation the machine 1 will produce a beverage consumption of about 120 ml.

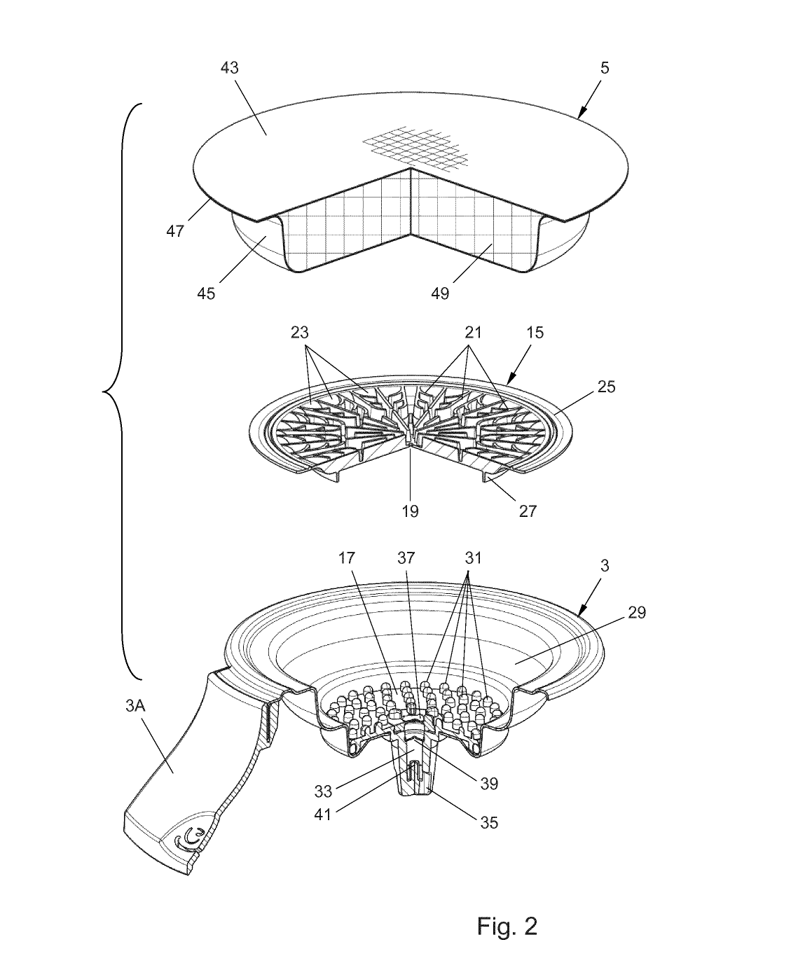

There has been a long felt need to be able to prepare a more concentrated beverage, such as espresso coffee with the same machine. To this end the present invention proposes to insert an adapter 15 between the standard pad 5 and a bottom 17 of the pad holder 3. The adapter 15 is generally disc-shaped and provided with a restricted opening 19. On an upper side of the adapter 15 a beverage collecting structure is formed by a plurality of radial ridges 21 defining radial channels 23 therebetween, which are in fluid communication with the restricted opening 19. Furthermore the adapter 15 has a flexible and resilient perimeter flange 25 and a downwardly protruding circular rib 27. The resilient perimeter flange 25 is adapted to engage the inner boundaries of a bowl shaped interior 29 of the pad holder 3, while the downwardly extending rib 27 engages between appropriate nipples 31 of a plurality of nipples 31 extending upwardly from the bottom 17 of the holder 3. It is further seen in FIG. 2 that the holder 3 has an outflow funnel 33 and an exit opening 35. At an entrance of the outflow funnel 33 there may be provided a sieve 37, while in the outflow funnel 33 a nozzle 39 and a jet impact surface 41 are provided for a purpose to be described. The standard pad 5 in the usual manner has a covering of filtering material that comprises a top sheet 43 and a bottom sheet 45 that are connected around their confronting perimeter edges 47 to define an interior space filled with an extractable or soluble beverage preparation product 49. The standard Senseo® coffee machine, in a default setting, prepares 110-130 ml of beverage. For the restricted opening 19 to form a restriction, it needs to have a diameter smaller than that of the nozzle 39 of the holder 3. The restricted opening 19 of the adapter 15, advantageously has a diameter less than 0.83 mm, and preferably a diameter within a range from 0.58 to 0.64 mm.

In use, when the adapter 15 and the pad 5 are inserted in the holder 3, hot water under pressure that is fed to the top sheet 43 will dissolve or extract the beverage product 49 and a beverage fluid will be collected and guided from the bottom sheet 45 by the radial channels 23 to the restricted opening 19 and leave the holder 3 through the sieve 37 and the exit opening 35.

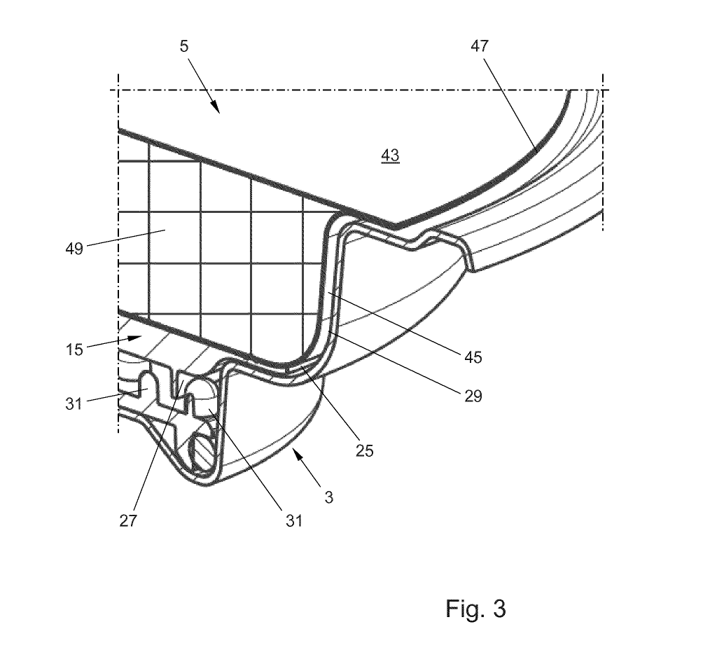

Because the opening 19 in the adapter 15 is a restriction, a substantially reduced amount of beverage will result when the hot water supply is time controlled, as is the case with the known Senseo® coffee machine. Such a reduced amount of beverage can be predetermined by the size of the restricted opening 19 and is advantageously chosen to obtain about 80-90 ml of a highly concentrated, high quality beverage. For the restricted opening 19 to be effective, it is important that the necessary higher pressure drop across the pad 5 and the adapter 15 is made possible by a seal effective enough to prevent the pressurized hot water to bypass the pad 5 and to exit the exit opening 35 without padding the beverage product 49 in the pad 5. To this end the resilient perimeter flange 25 of the adapter 15 is sized to be slightly larger than an inside diameter of the bowl-shaped interior 29 of the pad holder 3. As shown in FIG. 3 on an enlarged scale the perimeter flange 25 of the adapter 15, when inserted into the bowl-shaped interior 29 of the pad holder 3 is bent slightly upwardly, while the adapter is held in this position by the volume of the pad 5, which is also accommodated in the pad holder 3. As a result the perimeter flange 25 resiliently engages the bowl-shaped interior 29 of the pad holder 3 and assisted by the hot water pressure effectively prevents any bypass of water. In this manner all the pressurized water is forced through the restricted opening 19 (FIG. 2). This raises the pressure drop across the pad 5 and reduces the flow rate of the hot water. A reduced flow rate in combination with a time controlled hot water supply results in a reduced amount of beverage.

A jet of beverage that leaves the restricted opening 19 is likely to be a turbulent flow, which may render the nozzle 39 and impact surface 41 of the pad holder 3 ineffective. In the conventional situation when no adapter is used the beverage fluid leaving the bottom filtration sheet 45 of the pad 5 will arrive from between the plurality of nipples 31 on the bottom 17 of the holder 3 to the sieve 17 as a laminar flow. This laminar flow when forced through the nozzle 39 will impact upon the impact surface 41 and then leave the exit opening 35 as a fine bubble foam layer, which will float on top of a beverage collected in a beverage receptacle, such as a cup or a mug. With the adapter 15 according to the embodiment of FIG. 2 a beverage without foamy head may be obtained.

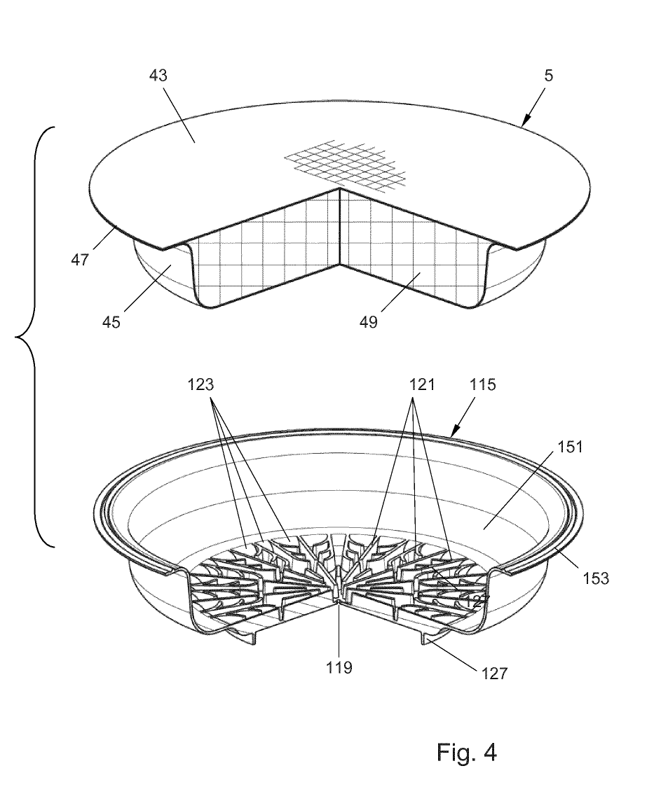

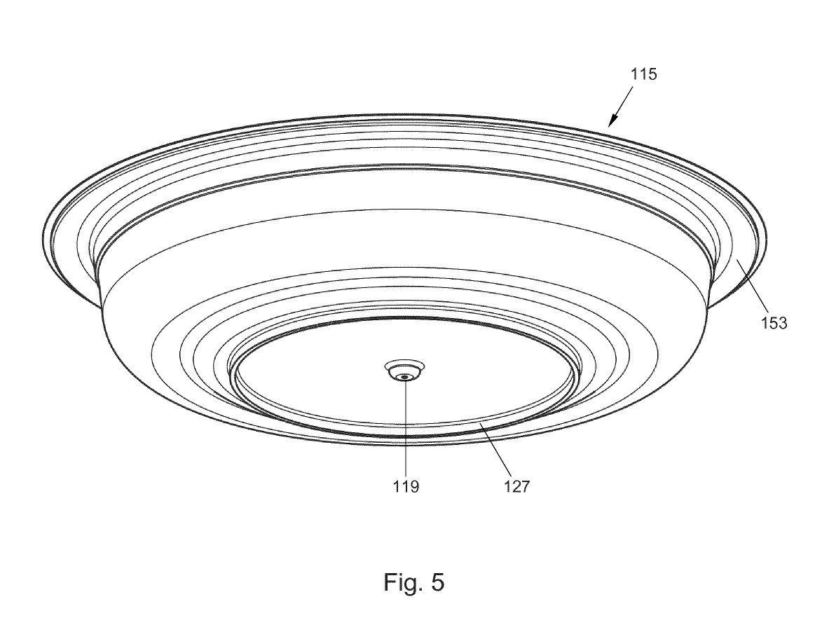

FIGS. 4 and 5 show a first alternative embodiment of adapter 115. The adapter 115 has a bowl-shaped interior 151 and an outwardly extending perimeter flange 153. The outwardly extending perimeter flange 153 is adapted to overly a flat upper perimeter surface of the pad holder 3 (see FIG. 2) and be between the connected perimeter edges 47 of the pad 5 and the holder 3 when in use. The exterior form of the adapter 115 is adapted to mate closely with the bowl-shaped interior 29 of the pad holder 3. In all other respects a fluid collecting structure formed by radial ridges 121 and channels 123 is substantially identical with the embodiment of FIG. 2, as is the restricted opening 119. The pad 5 additionally illustrated in FIG. 4 may help to clarify the adaptation of the bowl-shaped interior 151 of the adapter 115 to the pad 5.

With the first alternative embodiment the adapter 115 and the pad 5 may be positioned in the holder 3 together, after prior insertion of the pad 5 into the adapter 115. With the adapter 15 of FIG. 2 it may be more convenient for the adapter 15 to be first placed into the pad holder 3, before the pad 5 is inserted therein. Nonetheless it is also conceivable that the adapter 15 of FIG. 2 is first adhered, by welding or gluing, to the pad 5, whereupon both can be inserted together into the pad holder 5.

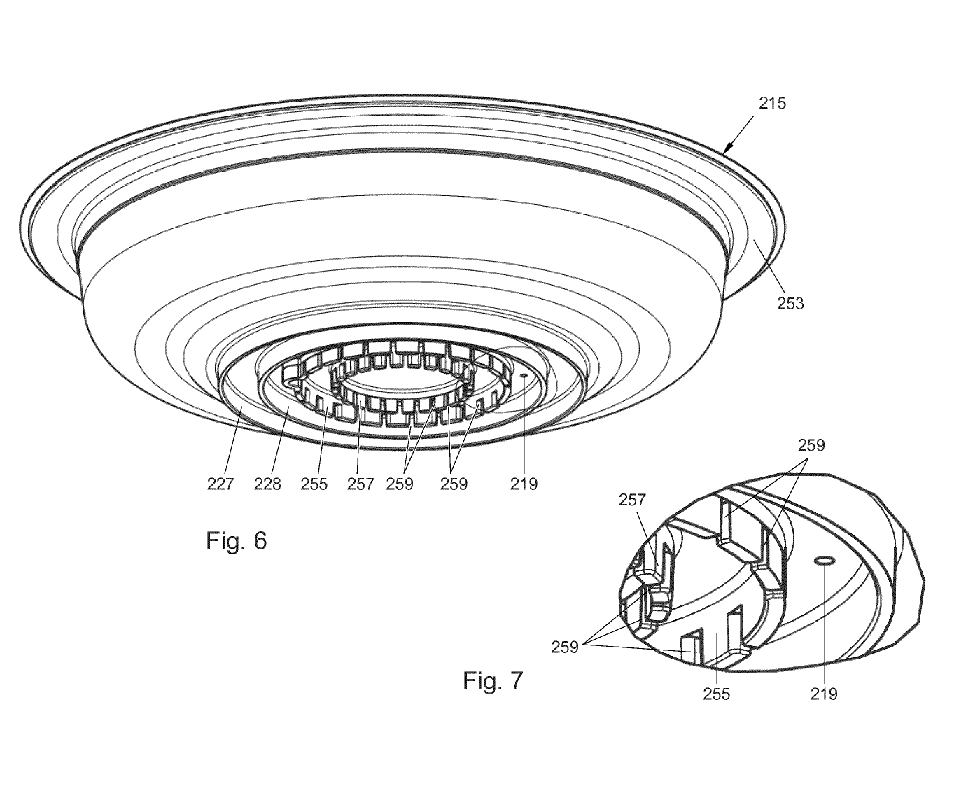

As has been explained in reference to FIG. 2 it may not be possible with the adapter embodiments of FIGS. 2-5 to obtain a beverage with a foamy head. When such would be the case and a foamy head would be required then the second alternative of adapter 215 according to FIGS. 6 and 7 may be employed. As in the embodiment of FIGS. 4 and 5 the reference numerals used to denote similar parts of the adapter 215 in FIGS. 6 and 7 are again a full “100” higher than those of the embodiment of FIGS. 2 and 3. While the adapter 215 is shown as one having a bowl-shaped interior, it should be understood that the feature that will be described below can also form part of an adapter that is similar to the embodiment of FIGS. 2 and 3. Similar to the adapter of FIGS. 4 and 5 the adapter 215 has an outwardly extending flange 253 to overly a horizontal top flange of a pad holder as illustrated in FIG. 2. The adapter 215, on its opposite side not visible in FIG. 6 may again have a beverage collecting structure comprising ridges and channels. The difference of the second alternative embodiment of FIGS. 6 and 7 is an arrangement within an outer circular rib 227 extending downwardly from the adapter 215. Inwardly of the outer circular rib 227 is an inner circular rib 228. Both inner and outer ribs 227 and 228 are adapted, in use, to be accommodated between opposed nipples 31 of the bottom 17 of the pad holder 3 (see FIG. 2). Inwardly of the inner circular rib 228 is an outer interrupted circular ridge 255 and an inner interrupted circular rib 257. Each of the interrupted outer and inner ribs 255, 257 is interrupted by a plurality of equally spaced slots 259 (see also FIG. 7). A restricted opening 219 is positioned off centre between the continuous inner rib 228 and the interrupted outer rib 255. In use with a pad inserted in the adapter 215, and the adapter and pad accommodated in a holder in a beverage machine the beverage exiting from the restricted opening 219 will be forced through the slots 259 of the interrupted outer and inner ridges 255, 257. In use the interrupted outer and inner ridged 255, 257 will also extend between the nipples 31 provided in the bottom 17 of the pad holder 3 (see FIG. 2), so that a labyrinth type path towards the outflow funnel 33 is formed. An effect of this labyrinth path is that a turbulent flow of beverage from the restricted opening 219 is converted into a laminar beverage flow. This laminar beverage flow when it is forced through the nozzle 39 of the pad holder 3 (FIG. 2), will form a jet that impacts on the impact surface 41 to obtain a beverage from the exit opening 35 that will form a foamy head in a receiving receptacle.

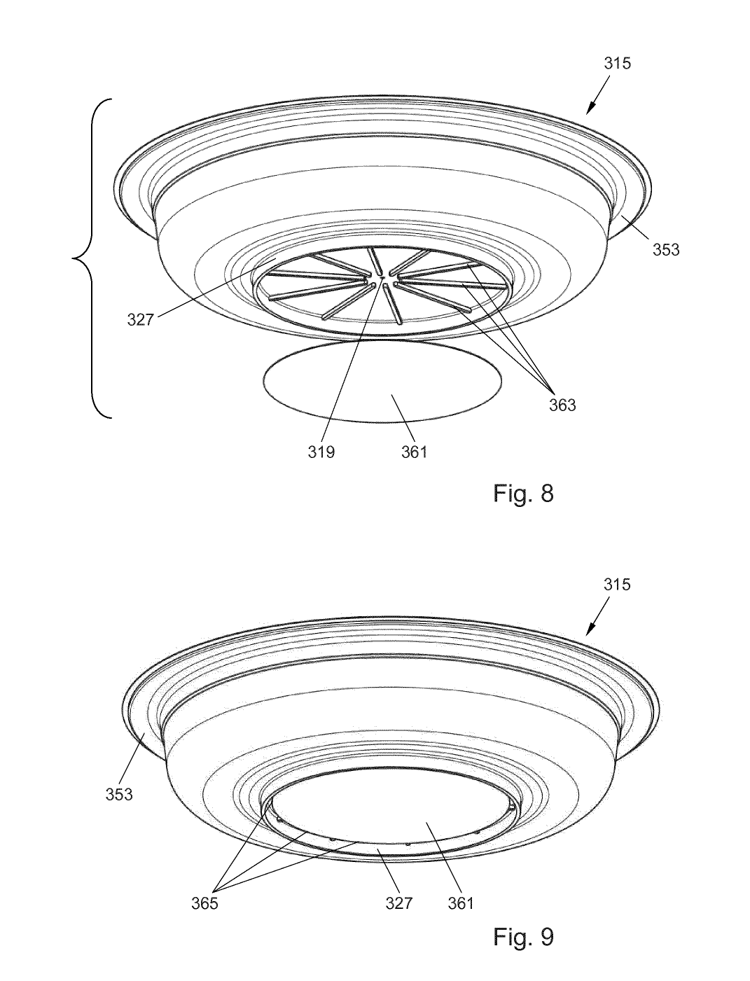

A third alternative form of adapter 315, as shown in FIGS. 8 and 9 may also be employed to obtain a laminar flow of beverage and a foamy head on a beverage by the foaming means provided in the pad holder 3. As shown in FIG. 8 the adapter 315 is about to receive a deflector plate 361. The deflector plate 361 thereby will be attached to radially extending ribs 363 protruding from a bottom portion of the adapter 315 bounded by a downwardly protruding circular ridge 327. Attachment of the deflector plate to the radially extending ribs 363 may be by welding or gluing. The radially extending ribs 363 converge towards a central restricted opening 319 from which a beverage will leave the adapter 315. The deflector plate 361 has a diameter slightly less than an inner diameter of the circular ridge 327. As shown in FIG. 9, with the deflector plate 361 attached, gaps 365 are formed between the inside of the circular ridge 327 and the outer edge of the circular ridge 327 and the outer edge of the deflector plate 361. In use, any turbulent flow that exits the restricted opening 319 will spread out over upper surface areas of the deflector plate 361, defined between the radial ribs 363. This spreading-out will reduce the flow rate of the beverage and convert the flow into a laminar flow that exits from the gaps 365 and flows over the bottom 17 of the pad and convert the flow into a laminar flow that exits from the gaps 365 and flows over the bottom 17 of the pad holder 3 (FIG. 2) between the nipples 31 to the outflow funnel 33. While in the embodiment of FIGS. 8 and 9 it is explained that the ribs 363 are on the upper part of the adapter 315, it is also possible to provide these ribs alternatively on a top surface of a deflector plate 361, or on each of them.

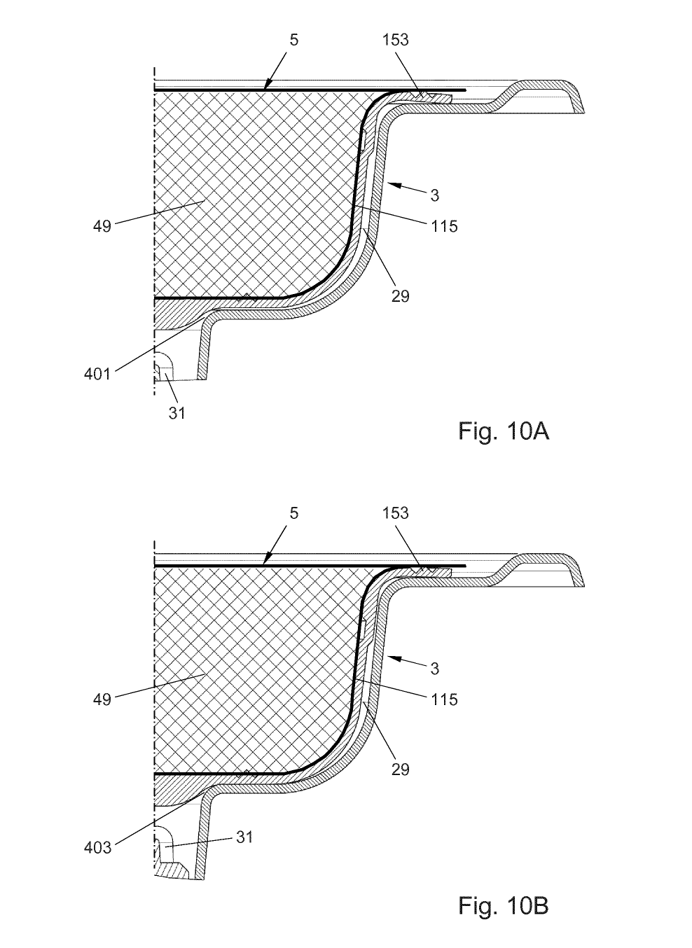

As best seen in FIGS. 10A and 10B, the adapter 115 and the pad holder 3 form a fluid seal, which is reinforced by the pressure drop over the adapter 115 and by properties of the substantially rigid shell of the adapter 115, that permit the shell to soften slightly at the brewing temperature and conform its shape to that of the bowl shaped interior 29 of the pad holder 3. In FIG. 10A the adapter 115 is shown when accommodated in the pad holder 3, without fluid pressure, and forming a static fluid seal. The static seal between the adapter 115 and the pad holder 3 is formed between an outwardly extending perimeter flange 153 of the adapter 115 at its outer perimeter edge and a confronting outwardly directed flat upper perimeter surface of the pad holder 3. Sufficient static sealing may already be obtained by gravity through the combined weight of the adapter 115 and the pad 5 being supported on the outwardly directed flange of the holder 3 via the outer edge of the outwardly directed perimeter flange 153. As shown in FIG. 10A the outwardly directed perimeter flange 153 of the adapter 115, inclines slightly downwardly in an outward direction, so that initial contact with the flat upper perimeter surface of the pad holder 3 will be through the outermost perimeter edge of the adapter 115. It is further seen in FIG. 10A that still a gap 401 exists between a remainder of the rigid shell of the adapter 115 and the bowl-shaped housing interior 29 of the pad holder 3. In FIG. 10B the adapter 115 in the pad holder 3 is shown, when pressed down by fluid pressure and forming an additional dynamic fluid seal, in that the flat bottom part of the adapter 115 now firmly contacts the bottom of the holder 3. Initial contact between the flat bottom part of the adapter 115 and the bottom of the pad holder 3 will start at a point 403 where the interior 29 of the holder 3 bends away toward the nipples 31 of a bottom structure of the pad holder 3. At this point the deflection of the adapter 115 under pressure forces its bottom part against the holder 3. The dynamic seal uses the fluid pressure to improve contact between the adapter 115 and the pad holder 3. The more pressure drop there is across the adapter 115 during brewing, the higher the contact pressure will be between the flat underside of the adapter 115 and the pad holder 3. It is thereby prevented that the hot water that has been fed to the top of the pad 5 can flow directly to the outlet of the pad holder 3 by bypassing the adapter 115. The beverage thus can only flow through the outlet (33 in FIG. 2) of the pad holder 3. While the static and dynamic fluid seal in the example of FIGS. 10A and 10B has been described in reference to the first alternative form of adapter 115 according to FIGS. 4 and 5, it will be clear that also the second and third alternative forms of adapter 215 and 315 could be substituted for the adapter 115 of this example.

Thus an adapter (15; 115; 215; 315) is described for use in a hot beverage machine (1) in combination with a pad (5), which pad comprises a covering (top sheet 43, bottom sheet 45, perimeter edge 47) of filtering sheet material enclosing a beverage preparation product (49). The beverage machine (1) has a pad holder (3) having a bowl-shaped interior (29), and a beverage exit opening (outflow funnel 33). The coffee machine has a water inlet and is arranged for supplying a time controlled amount of water to a pad (5) positioned in the pad holder (3). The adapter (5) comprising a rigid disc-shaped body having a beverage collecting structure (radial ridges 21; 121, radial channels 23; 123) on an upper surface, and a perimeter (flange 25; 153; 253, 353) arranged for sealing engagement with the pad holder (3) of the beverage machine (1), and for positioning between the pad (5) and the beverage exit opening (33). The adapter (15; 115; 215; 315) has a restricted opening (19; 119; 219; 319) extending therethrough to reduce in volume a beverage leaving the pad (5) and flowing to the beverage exit opening (33) of the pad holder (3).

It is thus believed that the operation and construction of the present invention will be apparent from the foregoing description and drawings appended thereto. It will be clear to the skilled person that the invention is not limited to any embodiment herein described and that modifications are possible which should be considered within the scope of the appended claims. Also kinematic inversions are considered inherently disclosed and to be within the scope of the invention. In the claims, any reference signs shall not be construed as limiting the claim. The term ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the structure of the invention within its scope. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Additions, deletions, and modifications within the purview of the skilled person may generally be made without departing from the spirit and scope of the invention, as is determined by the claims.

1. An adapter for use in a coffee machine in combination with a pad, which pad comprises a covering of filtering sheet material enclosing a beverage preparation product, and which coffee machine is equipped with a pad holder having a bowl-shaped interior for accommodating the adapter in combination with the pad, the coffee machine having a water inlet and is arranged for supplying a time controlled amount of water to the pad positioned in the pad holder, the pad holder having a beverage exit opening, the adapter comprising:
a rigid disc-shaped body having a beverage collecting structure on an upper surface; and
a perimeter arranged for sealing engagement with the pad holder of the beverage machine, and for positioning between the pad and the beverage exit opening,
wherein the adapter has a restricted opening extending there through to reduce in volume a beverage leaving the pad and flowing to the beverage exit opening of the pad holder.

2.-6. (canceled)

7. The adapter according to claim 1, wherein the restricted opening has a largest through-flow area in a direction, in use, perpendicular to a beverage flow through the restricted opening not exceeding 0.54 mm², and preferably within a range from 0.26 to 0.32 mm².

8. The adapter according to claim 7, wherein the restricted opening has a substantially circular shape with a diameter less than 0.83 mm, and preferably within a range from 0.58 to 0.64 mm.

9. The adapter according to claim 1, wherein the adapter is arranged, in use, to be positioned in a holder of the coffee machine, wherein the holder is provided with at least one beverage exit opening comprising a nozzle for generating a jet of fluid which, in use, impacts on a jet impact surface of the coffee machine for generating the beverage with a fine bubbled foam layer, wherein the adapter further includes a member configured for establishing, in use, a laminar flow of the beverage adjacent and towards the exit opening of the holder.

10. The adapter according to claim 9, wherein the member configured for establishing a laminar flow is arranged to provide, in use, a shortest flow path for the beverage, which extends between the at least one outlet opening of the adapter and the at least one exit opening of the holder and which is longer than a shortest flow path for the beverage, which would extend between the outlet opening of the adapter and the exit opening of the holder without the member configured for establishing a laminar flow.

11. The adapter according to claim 9, wherein the member configured for establishing a laminar flow includes at least one of a deflector for deflecting the flow of the beverage from the outlet opening of the adapter and a labyrinth for diverting a plurality of times the flow of the beverage from the outlet opening of the adapter.

12. The adapter according to claim 11, wherein the deflector is positioned downstream of the at least one outlet opening of the adapter.

13. The adapter according to claim 12, wherein the deflector is a deflector plate.

14. The adapter according to claim 12, wherein the deflector is a deflector foil.

15. The adapter according to claim 11, wherein the labyrinth is formed by at least one slotted circular rib of the adapter which extends downwardly from the shell and being adapted to extend in a recess formed between nipples protruding from a bottom of a holder, when it is inserted in a holder.

16. The adapter according to claim 13, wherein the deflector plate is spaced from the disc-shaped body by a plurality of radial ribs.

17. The adapter according to claim 16, wherein the radial ribs are integral with the disc-shaped body.

18. The adapter according to claim 16, wherein the deflector plate is bonded to the radial ribs.

19. (canceled)

20. The adapter according to claim 1, further comprising a substantially circular ridge extending downwardly from a lower surface, and adapted to extend into a recess in the pad holder.

21. An assembly of an adapter comprising a rigid disc-shaped body having a beverage collecting structure on an upper surface and a perimeter arranged for sealing engagement with a pad holder of a beverage machine, the pad holder having a beverage exit opening, and the perimeter being arranged for positioning between the pad and the beverage exit opening, and a pad comprising a covering of filtering sheet material enclosing a beverage preparation product, wherein the adapter has a restricted opening extending there through to reduce in volume a beverage leaving the pad and flowing to the beverage exit opening of the pad holder.

22. A system including a coffee machine equipped with a pad holder comprising at least one beverage exit opening and being arranged for accommodating a pad, a lid for closing the holder, and a fluid supply member configured for generating a time controlled amount of water under pressure into the holder, wherein the system further comprises an adapter comprising a rigid disc-shaped body having a beverage collecting structure on an upper surface and a perimeter arranged for sealing engagement with the pad holder of the beverage machine, and being arranged for positioning between a pad and the beverage exit opening, and at least one pad with a covering of filtering sheet material enclosing a beverage preparation product suitable for use in the coffee machine, wherein the adapter has a restricted opening extending there through to reduce in volume a beverage leaving the pad and flowing to the beverage exit opening of the pad holder.

23. The system according to claim 22, wherein the adapter forms a fluid seal with the pad holder, so that a flow of hot water around the pad is prevented.

24. The system according to claim 23, wherein the seal formed between the adapter and the pad holder is at least one of a static and a dynamic seal.

25. The system according to claim 24, wherein a static seal is formed between an outwardly extending perimeter flange of the adapter and a confronting flat top flange of the holder.

26. The system according to claim 24, wherein the adapter at its underside forms a dynamic fluid seal with the holder, so that a flow of aqueous fluid from a top side of the pad around the pad to the beverage exit opening of the holder is prevented.

27.-28. (canceled)

29. The system according to claim 22, wherein the hot water is supplied at a pressure of 1.5-2.2 bar absolute pressure, preferably 1.8-2.0 bar absolute pressure.

30. The system according to claim 22, wherein 50-120 ml, preferably 75-95 ml beverage is prepared with the system.

31. The system according to claim 22, wherein the pad holder is equipped with a nozzle for generating a jet of the beverage.

32. The system according to claim 31, wherein the at least one beverage exit opening of the pad holder is equipped with a nozzle, and wherein the restricted opening has a through-flow area smaller than that of the nozzle of the holder.

33. The system according to claim 31, wherein the at least one beverage exit opening of the holder is equipped with a nozzle, which forms a flow restriction for the exit opening of the holder, and wherein the outlet opening of the adapter comprises a largest through-flow area, which is smaller than a through-flow area of the nozzle of the holder.

34. (canceled)

35. The system according to claim 33, wherein the restricted opening has a circular cross section in a direction which, in use, is perpendicular to a flow of the beverage through the restricted opening, and wherein the outlet opening of the adapter comprises a largest diameter, which is smaller than a largest diameter of the nozzle of the holder.

36. The system according to claim 35, wherein the restricted opening has a largest diameter less than 0.83 mm, and preferably within a range from 0.58 to 0.64 mm.

37. The system according to claim 22, wherein the fluid is supplied to the first sheet of the pad with a pressure of 1.5-2.2 bar, preferably 1.8-2.0 bar absolute pressure and/or that 50-120 ml, preferably 75-95 ml beverage is prepared with the system.

38. The system according to claim 22, wherein in a given length of time during use, with the fluid supplied at a given pressure, 20-60 ml less beverage is obtained with the adapter, when using the same holder, and with the fluid supplied at the same given pressure during the same given length of time.

39. The system according to claim 38, wherein in the given length of time during use, the fluid is supplied at an absolute pressure of 1.5-2.2 bar, preferably 1.8-2.0 bar.

40. The system according to claim 22, wherein the adapter is arranged such that, in use when the adapter is positioned in the holder, a seal is formed between the adapter and the holder to reduce or prevent a flow of the fluid from a top side of the adapter around the pad to the at least one beverage exit opening of the holder is at least one of a static seal, which provides a sealing engagement between the adapter and the holder under the sole influence of gravity on the adapter, and a dynamic seal, which provides a sealing engagement between the adapter and the holder under the influence of the pressure of the fluid on top of a pad supported by the adapter.

41. The system according to claim 40, wherein the static seal is formed by a contact between a perimeter flange of the adapter, which extends outwardly and downwardly from the adapter and an outer edge of the holder.

42. The system according to claim 41, wherein the dynamic seal is formed between an outer portion of the adapter and the holder at locations positioned at a smaller distance to a centre of the adapter than the location of the static seal.

43. The system according to claim 40, wherein, in use, for a dynamic seal the fluid pressure is used to improve contact between the adapter and the holder.

44.-47. (canceled)

48. A method for preparing at least one part of a single beverage serving with an adapter comprising a rigid disc-shaped body having a beverage collecting structure on an upper surface and a perimeter arranged for sealing engagement with a pad holder of a beverage machine, the perimeter being arranged for positioning between a pad and a beverage exit opening of the pad holder, and at least one pad with a covering of filtering sheet material enclosing a beverage preparation product suitable for use in the coffee machine, wherein the adapter has a restricted opening extending there through to reduce in volume a beverage leaving the pad and flowing to the beverage exit opening of the pad holder, wherein the at least one pad and the adapter are placed in the pad holder equipped with the at least one beverage exit opening, closing the pad holder containing the pad with a lid that has at least one fluid opening, supplying hot water under pressure to the at least one fluid opening, so that the hot water is fed to the beverage preparation product in the pad, allowing a beverage formed in the pad to leave the pad via the restricted opening of the adapter, and allowing the beverage to leave the pad holder through the at least one beverage exit opening.

49.-50. (canceled)
